(19) United States
(12) Patent Application Publication
(10) Pub. No.: US 2025/0085948 A1
(43) Pub. Date: Mar. 13, 2025

(54) ROBOT ORIENTED APPLICATION STORE

(71) Applicant: SUDHEER SAJJA

(72) Inventor: SUDHEER SAJJA

(21) Appl. No.: 18/243,955

(22) Filed: Sep. 8, 2023

(51) Int. Cl. G06F 8/61; B25J 9/16

(52) U.S. Cl. CPC G06F 8/61; B25J 9/1656

(57) ABSTRACT

An application marketplace for robot-oriented software applications (robot app store) presenting robot users with a plurality of robot oriented applications (ROAs) for installation on the robot computing system by the robot user.

### FIELD

The disclosure generally relates to robot computer systems and particularly to an online marketplace for software applications, and more particularly to an online store for software applications specifically designed for use on robots computing systems for interface by robot users.

### BACKGROUND OF THE INVENTION

In a fast-changing world, the need for efficiency has given birth to mechanized humans—also known as Robots. Better poised to handle tasks more effectively and efficiently without the risk of burnout suffered by the ordinary human being, the need for robots is particularly underscored in the world of commerce where everyday, a plurality of tasks are required to be performed within very limited timeframes, yet only a few hands are available to perform these tasks and at the speed required for commercial growth and productivity.

Since the introduction of the first robot to the U.S in the 1960s, the technology embodied by robots have greatly improved, allowing for their use in multi-faceted industries ranging from hospitality to healthcare to service industries, performing a wide range of functions within these industries.

The expansive functionality of robots, however, remains largely underutilized. This is because there is not much software on the market designed to improve and embody robots with additional functionalities beyond the primary functions they were designed to perform.

Mobile phones for instance have transitioned from mere texting and phone call devices to devices capable of a multiplicity of functions; from entertainment to fitness aids to productivity tools and many more, same goes for computers.

Robots are becoming more complex and the need for software applications specifically designed to optimize and enhance their functionality is apt, given that functionality is by far the most important aspect of robot operations. One way to proffer solution to this challenge is the creation of an application store specifically designed for use in robots computing systems, offering a plurality of robot-oriented software for interface by robot users, granting them access to software products that increase the functionality of their robots.

### SUMMARY OF THE INVENTION

This document relates to systems and methods for providing via a robot's computing system an app store comprising a plurality of robot oriented applications (ROAs) for access by robot users. The robot application store may be maintained by a cloud based vendor or pre-installed in the robot computing system's memory at the point of sale.

In one implementation, a computer implemented method is disclosed, comprising; presenting to a robot user by one or more processors via a robot's interface device, an applications store for robot-oriented applications, the store providing a plurality of applications available for installation on the robot. Wherein the application store makes the said presentation of the plurality of robot-oriented applications to the robot user based on an industry-use categorization; Receiving from the robot user, a request to install at least one of the plurality of applications on a robot computing device; Determining by one or more processor the compatibility of one or more selected robot-oriented applications with the robot on which the computing device is located and based on this determination, enabling, or disabling the install function of the application store; and Installing, where the install function is enabled, by one or more processors, at least one of the selected one of the plurality of applications on the robot.

In another implementation a tangible, non-transient computer readable medium is claimed, having recorded thereon instructions, that when executed perform operations comprising; presenting to a Robot User by one or more processors on a robot's interface device, an application store for robot-oriented applications, the application store providing a plurality of applications available for installation on the robot's computing device. Wherein the application store makes the said presentation of the plurality of robot-oriented applications to the robot user based on an industry-use categorization; receiving from the robot user, a request to install at least one of the plurality of applications on a robot computing device; determining by robot's processor, the compatibility of the selected application with the robot on which the computing device is located and based on this determination, enabling, or disabling the install function of the application store; and installing, where the install function is enabled, by one or more robot processors, at least one of the selected one of the plurality of applications on the robot computing device.

In another implementation a device, comprising one or more processor(s) is claimed. The processor(s) operable to; present to a robot user an application store for robot-oriented applications, the application store providing a plurality of applications available for installation
on the robot's computing device. Wherein the application store makes the said presentation of the plurality of robot-oriented applications to the robot user based on an industry-use categorization; receive from the robot user, a request to install at least one of the plurality of applications on a robot computing device; determine the compatibility of the selected application with the robot on which the computing device is located and based on this determination, enabling, or disabling the install function of the application store; and
install, where the install function is enabled, by one or more robot processors, at least one of the selected plurality of applications on the robot computing device.

The details of one or more implementations are set forth in the accompanying drawings and descriptions below. Other features and advantages will be apparent from the detailed description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “application” refers to application software, also known as an application or an “app, is computer software designed to perform a particular function or set of functions. Software applications typically consist of a series of instructions or code written in a programming language that is executed by a computer system. Examples include; graphics software, navigation software, data processing software, communication software.

The term “Robot Oriented Applications”, also known as “ROAs” are software applications specifically designed to perform a particular function or set of functions on robot systems. A ROA typically consists of a series of instructions or code written in a programming language that is executed by a robot computer system.

The term “application store” refers to a digital application distribution platform that allows users to browse and download applications from an online store. Applications are available either for free or at a cost. Applications can be downloaded directly to a target device.

The term “computer-readable medium” as used herein refers to any tangible storage and/or transmission medium that participates in providing instructions to a processor for execution. Such a medium may take many forms, including but not limited to, non-volatile media, volatile media, and transmission media.

The terms “determine”, “calculate” and “compute” and variations thereof, as used herein, are used interchangeably and include any type of methodology, process, mathematical operation or technique.

The term “display” refers to a portion of a screen used to display the output of a computer to a user.

The term “display device” refers to an interactive interface device with a display screen used for displaying a computer output to a user and receiving input from a user.

The term “means” as used herein shall be given its broadest possible interpretation in accordance with 35 U.S. C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “touch screen” or “touch sensitive screen” refers to a physical structure that enables the user to interact with the computer by touching areas on the screen and provides information to a user through a display. The touch screen may sense user contact in a number of different ways, such as by a change in an electrical parameter (e.g. resistance or capacitance), acoustic wave variations, infrared radiation proximity detection, light variation detection, and the like.

The term “server” refers to a computer or a computer program that provides specific services or resources to other computers or devices, typically over a computer interactive network such as the Internet. A server is designed to handle requests from client devices and deliver the requested data or perform the requested functions. A server can be a physical hardware device, a virtual machine, or a software program running on a computer. It is responsible for processing and responding to client requests, managing resources, storing, and retrieving data.

From the foregoing disclosure and the following more detailed description of various preferred embodiments it will be apparent to those skilled in the art that the present invention provides a significant advance in the technology of robot-oriented software.

Particularly significant in this regard is the potential the invention affords for increasing the functionality of robots. Additional features and advantages of various preferred embodiments will be better understood in view of the detailed description provided below.

The foregoing presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

### BRIEF DESCRIPTION OF THE DRAWINGS

FIG. 1 depicts a representation of the operation of a system for providing robot-oriented applications via an application store for use by robot users;

FIG. 2 depicts a representation of an example of a robot interface device as a touch sensitive display device;

FIG. 3A depicts a first representation of a graphical user interface of a robot interface device according to an embodiment;

FIG. 3B depicts a second representation of a graphical user interface of a robot interface device according to an embodiment;

FIG. 4 depicts a representation of an install page graphical user interface displayed by a robot interface device according to an embodiment;

FIG. 4B depicts a representation of an install page graphical user interface displayed by a robot interface device according to an embodiment;

FIG. 5 depicts a representation of a personal applications page graphical user interface displayed by a robot interface device according to an embodiment;

FIG. 6A depicts a first representation of a graphical user interface providing an upload page for software developers to submit developed robot-oriented applications on a robot-oriented applications store;

FIG. 6B depicts a second representation of a graphical user interface providing an upload page for software developers to submit developed robot-oriented applications on a robot-oriented applications store;

FIG. 7 depicts a representation of a graphical user interface providing a portfolio page for software developers to monitor robot-oriented applications published by them on a robot-oriented applications store;

FIG. 8 depicts a representation of a graphical user interface providing a release page for software developers to submit new releases of the robot-oriented applications published by them on a robot-oriented applications store;

FIG. 9 depicts a representation of a graphical user interface providing a team page for software developers with robot-oriented applications published on the on a robot oriented applications store to view the activity of other team members on the robot oriented application store with respect to their published applications;

FIG. 10 depicts a representation of a graphical user interface providing a metrics page for software developers with robot oriented applications published on the on a robot oriented applications store to observe the performance of robot oriented applications published by them on a robot oriented applications store;

FIG. 11 depicts a representation of an algorithm of the operation of a robot application store according to an embodiment of the present invention;

FIG. 12 shows a flowchart of an algorithm of an installation subroutine according to an embodiment of the present invention;

FIG. 13 shows a flowchart of an algorithm of an update subroutine according to an embodiment of the present invention;

FIG. 14 shows a flowchart of an algorithm of a launch subroutine according to an embodiment of the present invention;

### DETAILED DESCRIPTION OF EMBODIMENTS

Systems, methods and apparatus which implement the embodiment of the various features of the present invention will now be described with reference to the drawings. It should be noted that the drawings and associated descriptions are provided to illustrate some embodiments of the present invention and not to limit the scope of the present invention. Throughout the drawings, reference numbers are re-used to indicate correspondence between reference elements. In addition, the first digit of each reference number indicates the figure in which the element first appears.

### Robot Appstore System

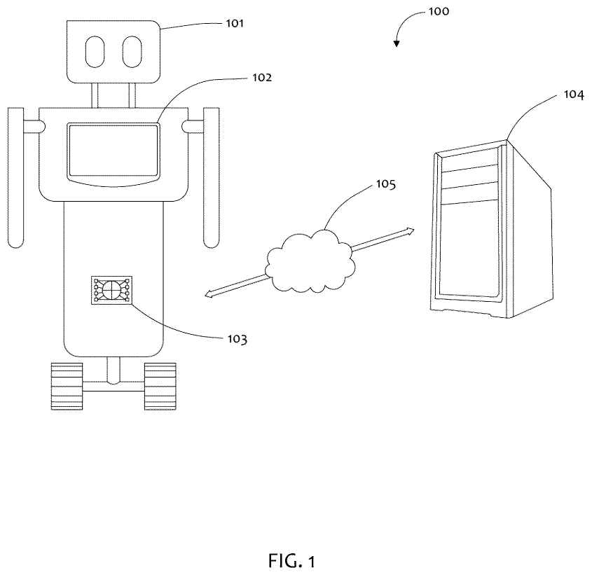

FIG. 1 shows a conceptual diagram of an example of a system of providing robot oriented applications via an app store for use by robot users.

The system in general provides robot users with robot oriented applications for download and installation on their autonomous robots. In the example of FIG. 1, the system 100 includes an application store server 104, a robot interface device 102, a robot computing device 103 and an autonomous robot 101 wherein the robot computing device 103 (control board) is located as well as a computer interactive network 105 facilitating communication between the communication device of the autonomous robot and the application store server 104.

The Autonomous robot 101 is a self-driving robot that can operate on its own without human intervention, they can be referred to as robots capable of some degree of self-sufficiency. Autonomous robots may be able to perceive their environments and make decisions based on these perceptions and what they have been programmed to recognize. Following this, they may actuate a movement or manipulation within that environment.

The Autonomous robot 101 is shown as a graphical depiction of a robot in a mechanical form of a person having a head, arms, wheels and a robot interface device 102 and a robot computing device 103 on it.

In some embodiments, one or more of the robot components may be custom designed for a specific robot or for a particular model or type of robot. In other embodiments, one or more of the robot components may be generic to many different robots and/or types of robots. The autonomous robot 101 may have one or more communications devices and interfaces for communicating with the application marketplace server 104 (as shown in FIG. 1).

The autonomous robot 101 may access the robot applications store server 104 via at least one interactive computer network 105, such as the World Wide Web via the Internet. In such an embodiment, the application marketplace server may be accessed through a website whereby the robot oriented applications store software package may be downloaded and installed on the autonomous robot 101.

In some embodiments the autonomous robot 101 may have a Robot computing device 103 which may embody a storage unit used for storing data from various sensors of the robot 101 and for storing downloaded software such as robot-oriented applications on the robot. The storage unit may also be used for storing program instructions for execution by a processor. The robot computing device may further embody one or more processors or other data processing subsystems. As stated above, the processor(s) may execute program instructions from robot-oriented applications. The processor(s) may be coupled to the storage unit and may be configured to control the robot 101 based on the program instructions stored at least partially in the robot computing device storage. The processor may also be configured to receive and interpret data from the various sensors on the autonomous robot 101. Examples of sensors that may be configured for use on the robot 101 include, for example, exteroceptive sensors such as; light sensors, ultrasonic sensors, infrared sensors, microphones, gyroscopes, accelerometers, cameras, radars, capacitive sensors, touch sensors. Proprioceptive sensors, or any other type of sensor now known or later developed.

The autonomous robot 101 may further have a robot interface device which may be configured to receive instructions from a robot user for execution on the robot by the processor(s). The robot interface device may have one or more processors configured to receive various signals such as, but not limited to; an installation signal, an update signal and a launch signal. The interface processor may be configured to install a robot oriented application on the robot upon receiving an installation signal, update an installed application upon receiving an update signal and launching a robot oriented application upon receiving a launch signal. In some embodiments, the robot interface device and the robot computing device may be coupled as one unit on the autonomous robot 101.

The autonomous robot 101 may embody electromechanical actuation devices configured to enable the robot 101 move about its environment or interact with objects in its environment. For example, the autonomous robot 101 may have one or more electromechanical devices, such as motors, wheels, movable arms, electromagnets, hands, grasping claws, tool attachments, etc., that enable the autonomous robot 101 to move about its environment, interact with objects located in its environment, and/or perform tasks with objects in its environment. The autonomous robot illustrated in FIG. 1 may be configured to operate according to a robot operating system, e.g., an operating system designed for specific functions of the robot. A robot operating system may provide libraries and tools (e.g., hardware abstraction, device drivers, visualizers, message-passing, package management, etc.) to enable robots to execute robot applications. Examples of robot operating systems include open source software such as ROS (robot operating system) and any other robot operating system now or later developed.

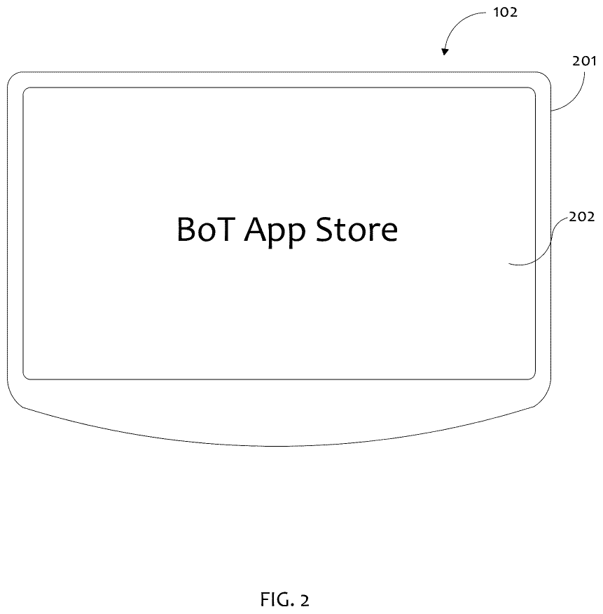

FIG. 2 is a graphical representation of an example of a robot interface device 102 as a touch sensitive display device. The interface device as shown in the diagram may be a display device with a touch sensitive screen 202, that is used by the robot user to send instructions to the robot computing device 103, to be executed on the robot. A user may interface with the robot application store via the robot interface device 102 which may in some embodiments be onboard
the autonomous robot 101 as in the graphical depiction of the autonomous robot 101 in FIG. 1. In other embodiments, the robot interface device may be an external device like a smartphone or a laptop configured to be in communication with the robot computing device 103.

The robot computing device 103 may take on the task of executing instructions input on the robot interface device 102 by the robot user, on the robot. The robot computing device 103 serves as a centralized control system or a control board, orchestrating the robot's actions and operations. The robot computing device 103 employs one or more processors optimized for autonomous robotic applications. The processor(s) execute complex instructions received from the robot user through the robot interface device 102 as well as other preprogrammed instructions, carrying out sophisticated computations necessary for the robot's autonomous capabilities. The robot computing device may also be configured to receive commands from external user interface devices such as a laptop, tablet or mobile devices which the robot user may use to send instructions of tasks to be executed on the robot by the robot computing device via the autonomous robot 101 communications interfaces mentioned above which may include wired or wireless interfaces.

The user may execute instructions via the robot interface device 102, such as downloading and installing, launching, uninstalling the robot oriented applications hosted on the robot application marketplace server 105. The user may further access one or more of selected applications, such as through the robot application marketplace server or applications installed on the robot computing device and run/or display the applications.

In embodiments, the robot interface device 102 may receive input from a number of different sources other than a touch sensitive screen 202 as in the example of the display device 201, including physical, electrical and/or audible commands from the robot user. These input sources are non-limiting, and the robot user may receive input from a combination of these sources.

As can be appreciated, the description of the robot interface device as a display device having a touch sensitive screen is made for illustrative purposes only and the embodiments are not limited to the specific mechanical features shown in FIG. 2 and described above.

In embodiments, the display device is adapted to run/and or display one or more applications, obtained through the application store. An application may be displayed onto touch sensitive screen 202 wherein the robot user interfaces with the apps on the robot-oriented applications store. In another embodiment, depending on preference, the robot user may interface with the apps displayed on the display device via an audio interface. In yet another configuration, the audio interface provides, by audio output and for a selected menu selection, each application on the robot-oriented application store to the user, through spoken command, access the various options and operations of the application store.

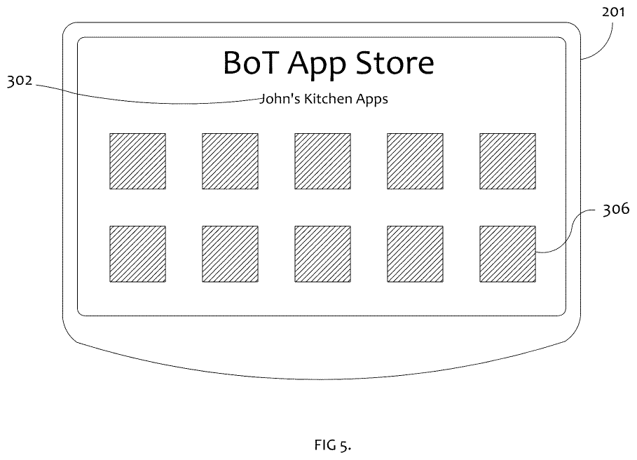

The display device 201 may be configured to provide the robot user access to robot oriented application on the application marketplace and/or via one or more icons. Whether an application or applications have been installed, or are yet to be installed from the application marketplace may be indicated on the display device 201. An application that has been installed may be presented to a robot user on a separate window of the application store graphical user interface as seen in the example of FIG. 5.

In embodiments, an installed application may be designated to be accessed by the robot user on the display device 201 without running the robot application store and configured to remain accessible on the display device 201 or other associated display device. The installed applications and/or icons may be moved and positioned in various locations on the display device 201.

As described above, the robot computing device may embody processors, sensors, and storage unit(s). The computing device may be configured to receive data from the autonomous robot sensors and process these data, facilitating the robot computing device's real-time decision-making, and seamless integration with the robot's subsystems.

The application marketplace server 104, on the other hand is a system that includes at least one server computing device that implements an online software store that allows robot users to, among other things, browse and download robot oriented applications onto compatible robot computing devices. The application store may be maintained by a remote server and/or be prestored in the robot's computing device memory at the point of sale.

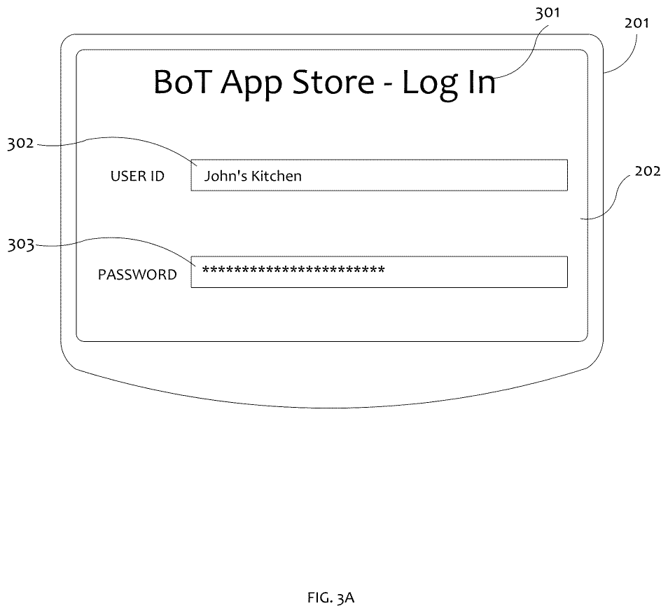

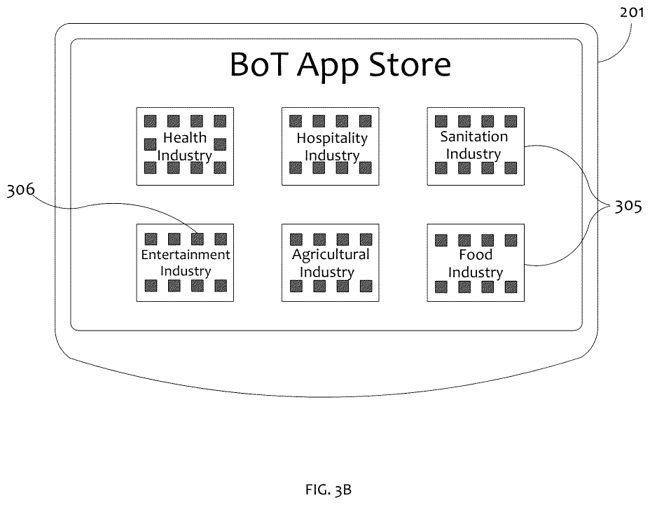

Graphial User Interface of Robot Oriented Application Marketplace FIGS. 3A, 3B, 4 and 5 represent various embodiments of an autonomous robot's interface device displaying the graphical user interface of the robot application marketplace in accordance with embodiments, icons, applications, and/or automatically via a processor. As can be appreciated, the description of the display device 201 is made for illustrative purposes only, and the embodiments are not limited to the specific mechanical features shown and described in FIGS. 3A, 3B, 4 and 5.

In other elements, the display device 201, may include additional features, including one or more additional buttons, slots, and/or shapes. Additionally, in embodiments, the features described above may be located on different areas of the display device 201 and still provide similar functionality. Therefore, FIGS. 3A, 3B, 4 and 5 and the description provided above are non-limiting.

In the example of FIG. 3, a representation of a graphical user interface of a display device 201 with a touch sensitive screen 202 is shown wherein areas the robot application marketplace interface is in a lock-mode display.

The robot user may bypass the lock-mode interface 301 of the marketplace application by inputting their user identification string 302 and unique password 303 information on the robot interface device 102. The robot oriented application store may identify each marketplace user using their User Identification 302 string in conjunction with their password 303 and each password may be unique to the identification string which it is assigned. If the robot user's identification string 302 and unique password is verified as correct by the application store, the user may be allowed access to the robot oriented applications store.

The lock mode functionality may be relevant to enable the primary robot user limit or control various levels of access to robot oriented applications installed on the autonomous robot by the robot user as well as limit of control the access to various functionalities of the robot oriented application store. For example, the primary operator's User identification string and password may offer them access to certain features of the robot oriented application store, they have limited secondary operators access to, such as the primary robot user been able to download and install robot oriented applications from the robot oriented applications store while the secondary user is only allowed to launch applications from the application store and not make new downloads on the store.

As shown in the example of FIG. 3B, upon accessing the robot application store, the robot user may be presented with an option of a plurality of robot-oriented applications for the user's download. The ordering of the robot oriented application icons 306 may be based on their suitability to use in particular industries 305. Certain robot-oriented applications may for instance, be better suited for use in restaurants and by extension the food industry. A user of a robot designed for use in restaurants may upon selecting the food industry icon presented on the graphical user Interface, be presented with icons representing a plurality of ROAs for execution on robots designed for use in restaurants.

In another configuration the ordering of the application icons on the application store may be based on the installed applications on the robot computing device by the robot user or the robot user's organization as shown in the example of FIG. 5. FIG. 5 is a graphical representation of the graphical user interface of a display device featuring the robot-oriented applications installed by a user with the User ID string 302 “John Kitchen”. The User may upon been presented on the Graphical User Interface, with applications he has installed on the robot may make a selection to run any of the said installed robot oriented applications on the robot via the interface device. It should be noted that the processing resources required for running, or at least displaying, applications on the robot interface device 102 such as the display device 201 or may be split between processors that are associated with the robot interface device 102 or display device 201 and processors that are not associated with the display device/interface device.

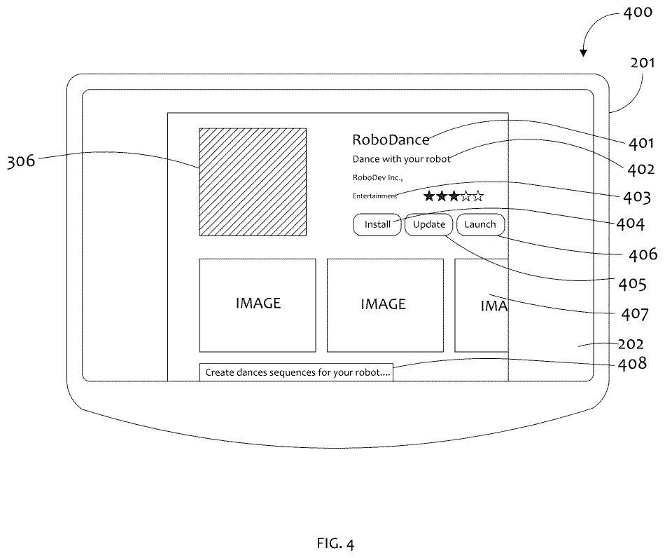

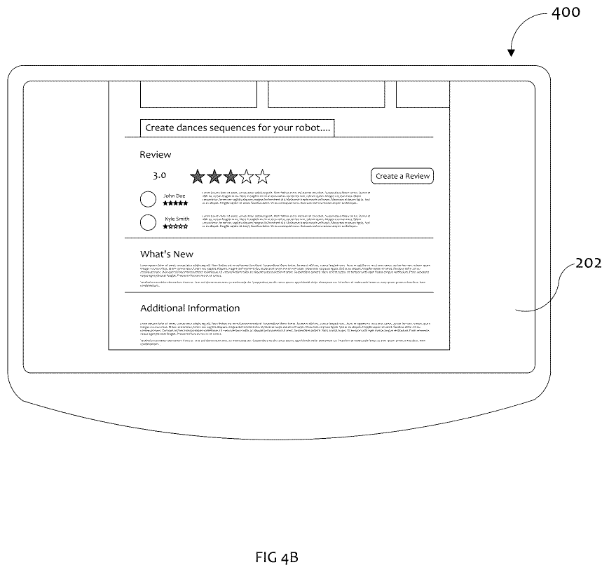

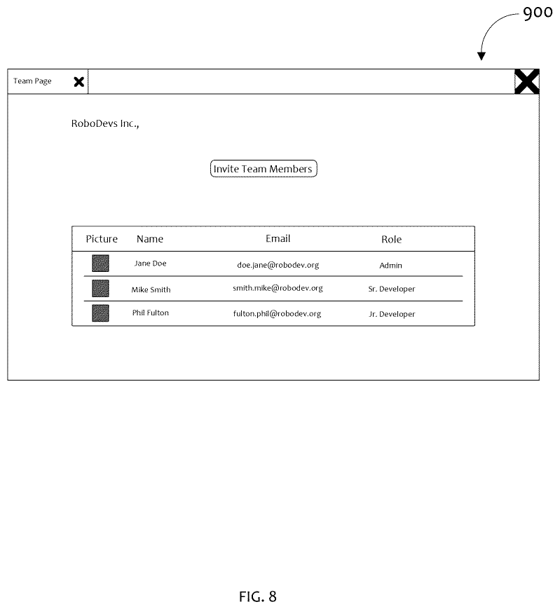

FIG. 4 depicts an example of a display window that shows up on the display screen when a robot user selects an application icon 306. The window 400 may outline, a name of the Robot oriented application 401, a brief description of the application 402, a description of the industry categorization 403 (for example, food, healthcare or hospitality industry) under which the application's use may be categorized, an install icon 404 wherein the robot user may select for execution of the installation function on the robot. Depending on whether the robot oriented application has already been installed on the robot or not, an update icon 405 or a launch icon 406 may be presented to the robot user as appropriate. In embodiments, the robot user may scroll down the display window on the touch sensitive screen for a more lengthy description of the robot oriented application on the application store as seen in FIG. 4B. On the display window 400 pictures showing the pages of the robot oriented application 407 may be displayed for the robot user to have a preview of the graphical user interface pages of the robot oriented application presented on the display window. The. Robot user may, by selecting the install function, download the ROA from the robot oriented applications store server and install the ROA on their robot. In such an embodiment, the application marketplace server may be accessed through a website whereby the robot oriented application store software package may be downloaded and installed on the autonomous robot 101 in the method described in FIG. 8.

In other embodiments, developers of software for use by autonomous robots 101 may upload their software for download by robot users on the application marketplace server 104 via a website created for the robot application marketplace.

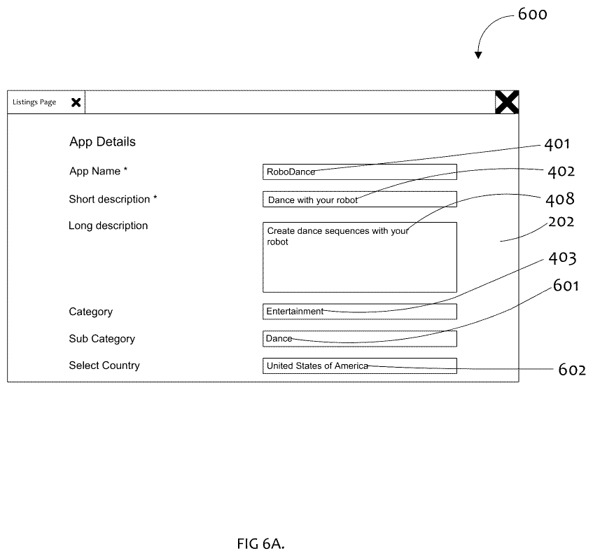

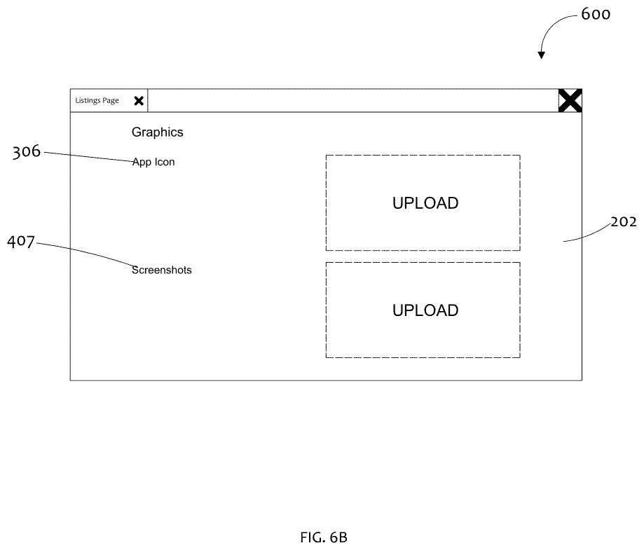

As shown in the example of FIGS. 6A and 6B a developer seeking to upload their robot oriented application on the application marketplace may be presented with forms to fill-in appropriate information regarding the ROAs they are seeking to upload on the robot oriented applications marketplace. This upload function may typically be accessible via the robot application marketplace website.

FIG. 6A outlines an example of a display window on the robot application marketplace website showing a listing form to be filled out by a software owner seeking to place their ROA on the robot application marketplace platform. The form may include various categories for the software developer to fill out, including the name of the ROA 401 sought to be posted. A brief description 402 and a long description 408 of the application sought to be posted. The brief and long description may include a marketing description of the application to intimate robot users with the functionality and uses of the ROA.

The listing required to be filled may further include industry categorization 403 information under which the ROA may be considered to fall under as well as a subcategory highlighting further specific industry category 601 for the application. A developer/software owner may also be required to provide the country where they operate out of as part of the listing requirement 602.

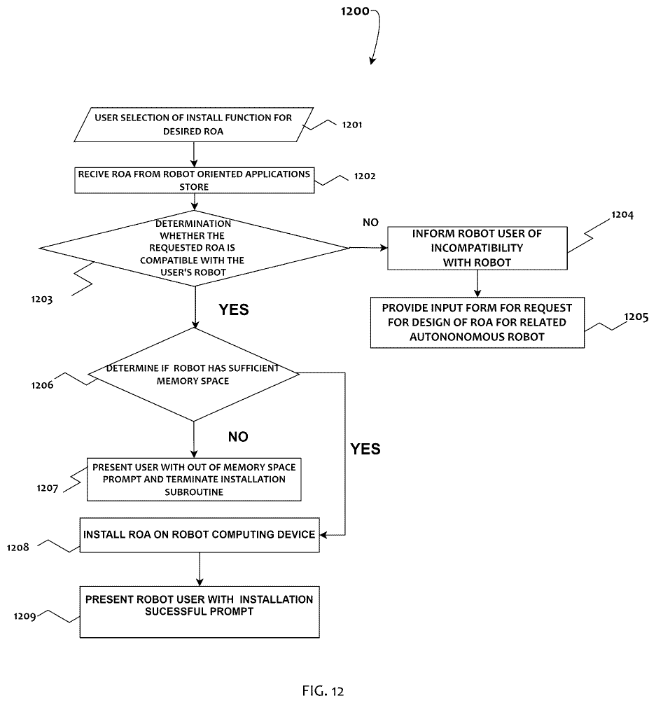

In the further example of FIG. 6B more fields may be provided for the software owner/developer to provide a graphical icon 306 for identifying and distinguishing the app for robot users as well as snapshot images of the GUI pages of the robot-oriented application 407 for robot users to have a preview of the graphical user interface pages of the robot oriented application sought to be uploaded to the robot application store platform. Sequel to providing the requisite and necessary information about the software on the application marketplace website, the software developer/owner may then upload their application package on the application marketplace server which will then be reviewed by the application marketplace management team. If the application marketplace management team authenticates the uploaded application, the uploaded application may then go live on the robot application store and be available for download in the manner described in FIG. 12.

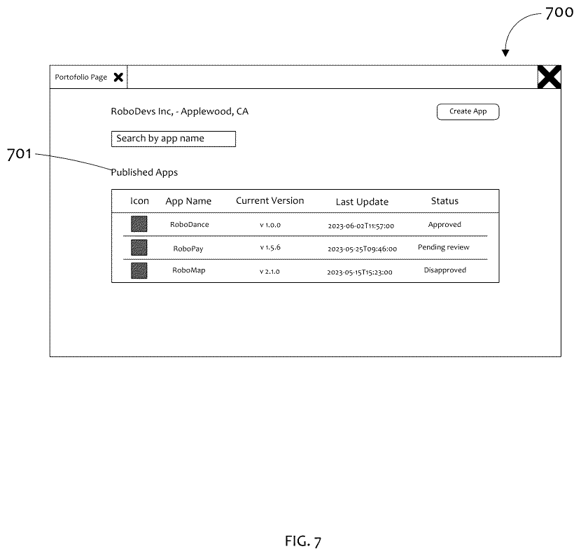

FIG. 7 depicts an example of a portfolio page 700 accessible on the application store website and shows software owners the status of the robot-oriented application software they uploaded and/or published on the robot application marketplace. The software owner may through the portfolio page access information about the status of the application i.e whether the application is still pending review from the robot application store management team or if the application had been approved and published on the marketplace or if the request to upload the application on the application store has been denied by the application store management team. In the example of FIG. 8, an iteration graphical user interface page 800 accessible via the robot app store website is shown wherein software owners may upload/submit updated releases or versions of robot oriented applications owned by them and published on the robot application marketplace. On the iteration page 800, software developers/owners may also be able to view to a status update tab, displaying the status of their version upload i.e, whether the update upload has been approved by the robot application store management team for publishing on the robot application store or whether the request for the upload has been denied or still pending review by the application store manager.

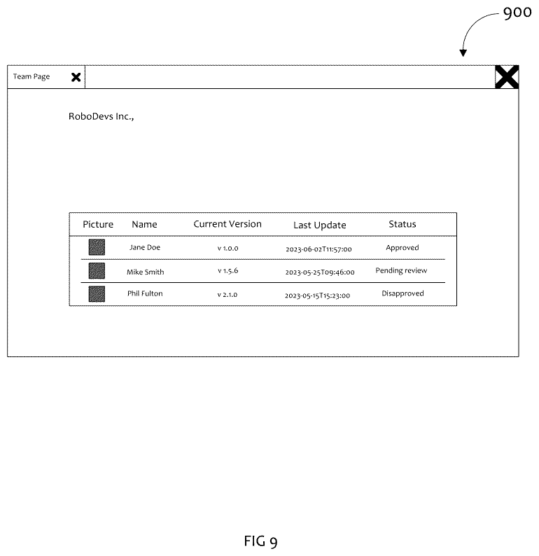

As shown in the example of FIG. 9 software organizations may provide various members within their organization access to the app store to manage and maintain the uploaded applications by their organization on the robot app store via a graphical user interface window 900 available on the application store website.

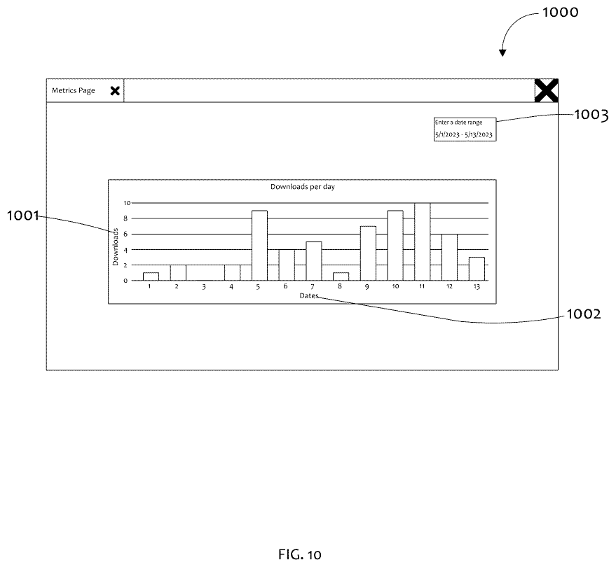

It is envisaged that software owners/developers who host their applications on the application store may wish to track the commercial success of their applications on the robot application marketplace. In the example of FIG. 10, a display window showing a metrics page 1000 wherein a graph depicting the number 1001 of robot users that installed the uploaded software application of a particular software owner on each day of the relevant month 1002 is indicated. Via the Metrics page 1000, the software owner may be able to view a log of installation activities on each day of a given month relating to a robot application uploaded by the software owner. The metrics page may include a date range function 1003 allowing the software owner to view installation activities regarding his uploaded software application within a selected time period.

### The Robot Oriented Application Store

We now turn to a discussion of the operation of the robot application store along with a discussion of algorithms of the robot interface software, which may be executed by a processor(s) for use in autonomous robots 101.

As stated above, the current disclosure relates to a robot oriented applications' store wherein robot users may purchase and download robot oriented applications (ROAs) for installation and/or execution on their robots.

Various applications that may reside on the app store may be robot control applications, application associated with at least one robot task, function, and operation, application related to accessibility robot graphical user interfaces web browser applications, communications applications, entertainment applications, robot diagnostics applications, robot productivity applications, weather information application, emergency service application, robot manual related application, robot tracking application utility applications and other various forms of applications that may enhance the functionalities of autonomous robots.

The ROAs on the app store may be categorized based on their relevance to a particular industry. Autonomous Mobile robots are usually designed to fit specific use-cases; their functionalities are most times better suited for application in certain industries than others. For instance, an autonomous food serving robot will be better suited for use in restaurants and dining facilities whereas an autonomous U.V disinfection robot will be better suited for use in healthcare facilities.

By the robot oriented applications store, a user may access ROAs that provide enhanced functionalities other than those configured on the robots by the OEM. The robot oriented applications store is configured to be a functionality enabler and provide robot users with a plurality of ROAs that allow them to execute added tasks.

For example a robot designed for use in restaurants and configured to simply convey meals from the kitchen to serve restaurant customers may acquire an added functionality by the robot app store, enabling the customers to make credit and debit card payments for their food by interfacing with a “RoboPay” application on the robot app store via the Robot's interface device.

Another example would be to have a robot similarly designed for transporting meals use in restaurants to acquire an added functionality via the robot app store, enabling the said robot to take customer's orders via a voice to transcript robot oriented application that allows the restaurant's customers to dictate their orders to the robot wherein the robot fills out the required order in a preset form and subsequently reports the transcript to the restaurant's kitchen for the order to be made.

In another example a robot configured to perform hospitality functions and simply welcome guests to a facility may acquire added functionality vis-à-vis the robot app store wherein the guest may interface with one or more applications from the robot app store via the Robot interface device, that allows the said guest to obtain information about the weather, particularly through a voice text interface with the robot.

In yet another example, an autonomous robot may acquire an added functionality to perform an entertainment dance routine by the user downloading and accessing an application from the Appstore that executes such instructions on the robot

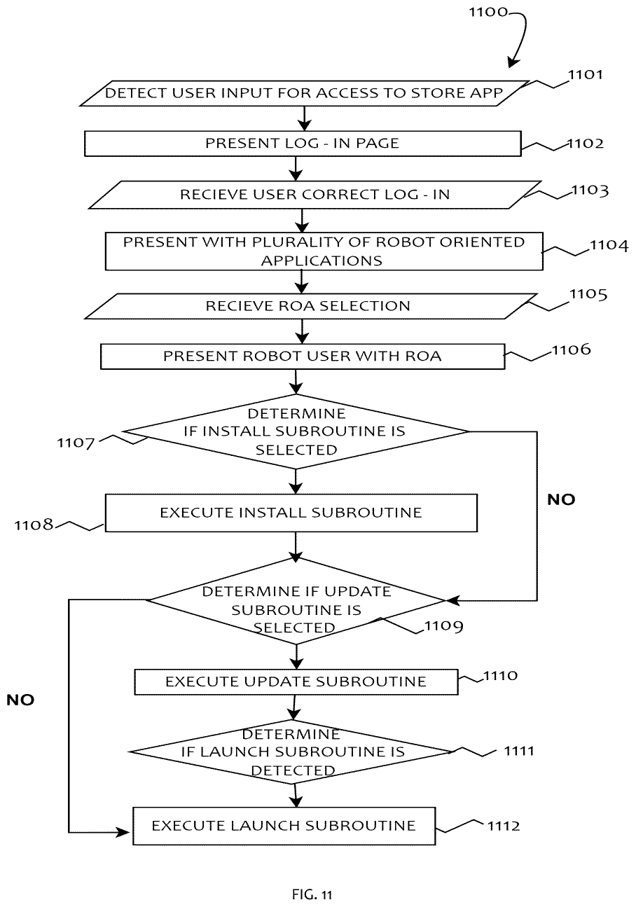

FIG. 11 is a flowchart of an algorithm of an operation of the robot-oriented application store application. When executed by a processor, the robot interface device 102 processor may perform the following method steps. In step 1101 the robot interface device processor may detect a user input requesting for the activation of the robot-oriented applications store app. In step 1102, the processor may present the robot user with a lock-mode interface, requiring the robot user to fill in an identification string and unique password as seen in the example of FIG. 3A. As exemplified in FIGS. 2, 3A, B and 4, the robot-oriented application store app interface may be presented to the robot user via an interface device such as a touch sensitive screen display device 201. In step 1103 the autonomous robot may receive input from the robot user of their correct user id and unique password. If the robot processor determines if it has received an accurate log-in input from the robot user. In step 1104 the processor may by the robot-oriented applications store app present the robot user with a plurality of robot oriented applications categorized based on their relevance to certain industries. The robot user may make a selection, choosing one from the plurality of robot oriented applications presented. In step 1105 the processor may receive a robot oriented application selection signal and upon determining that a robot oriented application has been selected by the robot user, the app store may in step 1106 present the robot user with a display window of the selected application as shown in FIG. 4. The display window may include the name of the ROA 401 and various interactive options such as an installation interactive option 404, an update interaction option 405, and a Launch interactive option 406. The robot user may touch the touch sensitive screen 107 and select any of the interactive options displayed on the window. The interactive options displayed may be dependent on whether the ROA is already installed on the relevant autonomous robot. In one configuration, where the ROA has not been installed on the robot, only the install interactive option may be presented to the user. In another configuration, where the ROA has already been installed on the autonomous robot, only the launch interactive option may be presented to the robot user, and depending on whether or not there are available updates for the relevant ROA on the application marketplace system, the update interactive option may or may not be available to the robot user.

In step 1107, 1109 or 1111 the processor may determine whether an, install, Update or Launch interactive option has been selected by the robot user and depending on the selection execute the corresponding installation, update or launch subroutine as shown in FIGS. 11,12 and 13 which will be discussed in detail in below. Although it is shown in FIG. 11 that the determination steps, 1107, 1109, and 1111 are performed in a particular sequence, the steps may be performed in parallel or in other sequences in various alternative embodiments.

In step 1107, the processor may determine whether an installation process is selected. For example, if the operator selects the installation icon 404, an installation signal (command) may be generated. Upon detecting the installation signal (command), the processor may determine that the installation process is selected, and it may perform step 1108. In step 1108, the processor may execute installation subroutine 1200 which will be discussed in detail in FIG. 12. If the installation signal (command) is not detected, the processor may determine that the installation process is not selected, and it may perform step 1109. In step 1109, the processor may determine whether an update process is selected. For example, if the operator selects the update icon 405, an update signal (command) may be generated. Upon detecting the update signal (command), the processor may determine that the update process is selected, and it may perform step 1110.

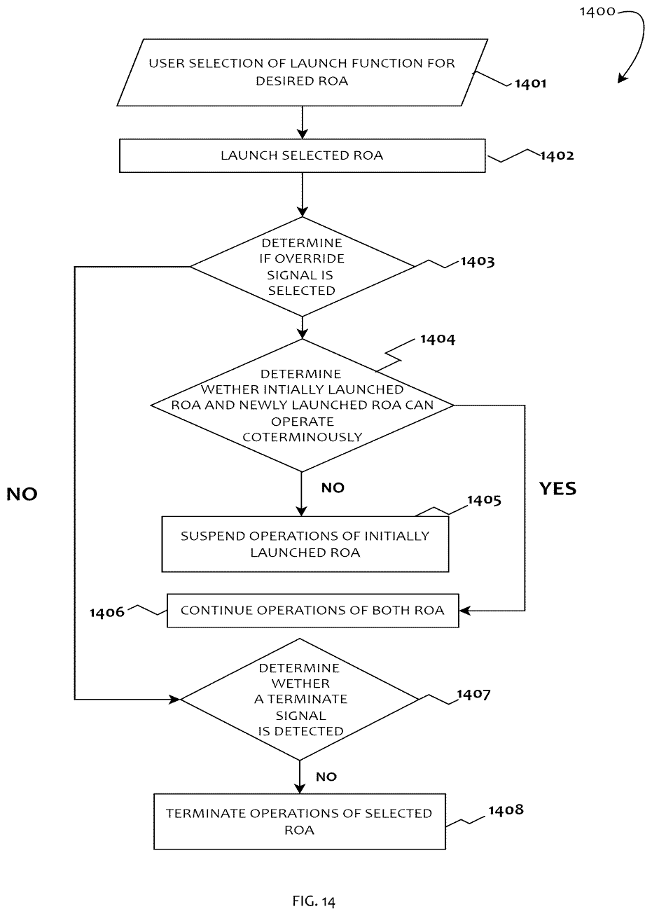

In step 1110, the processor may execute an update subroutine, which will be discussed in detail in FIG. 1300. If the update signal (command) is not detected, the processor may determine that the update process is not selected, and it may perform step 1111. In step 1111, the processor may determine whether a launch process is selected. For example, if the operator selects the launch icon 406, a launch signal (command) may be generated. Upon detecting the launch signal (command), the processor may determine that the launch process is selected, and it may perform step 1111. In step 1111, the processor may execute a launch subroutine 1112, which will be discussed in detail in FIG. 14.

FIG. 12 depicts the flowchart of an algorithm of an installation subroutine 1200 according to an embodiment of the present invention. Upon execution by a processor, the installation subroutine may cause the processor to perform the following steps: In step 1201 the processor may receive an input from the robot user via the robot interface device 102 requesting the install 404 of a ROA. In step 1202, the processor may receive a Robot oriented application from the robot application store remote server via a computer interactive network which may be accessed using the communication device of the autonomous robot. In step 1203, the processor may determine whether the received ROA is designated by the application developer for use on the relevant autonomous robot. The said determination may be based on one or more data of the type, make, model and/or year of manufacture of the autonomous robot 101. If the received ROA is not compatible for use on the relevant robot, the installation process may be terminated and the processor may, in step 1204, relay an installation failed report, which may be presented to the robot user on the touch sensitive screen 202 via the display device 201. In step 1205, following the presentation of the installation-failed report, the processor may via the user interface present the robot user with an input form offering the robot user the option to make a request that a version of the failed installed ROA be designed by the management of the robot oriented application marketplace to enable such users of the relevant robot, use ROAs of that sort on their robot in the future.

In another configuration, if the ROA is determined to be designated for use on the relevant autonomous robot, the installation process may proceed to step 1206. In step 1206 the processor may check for available memory space in the autonomous robot 101, such as the robot computing device 103 memory for storing the received ROA. If the robot computing device 103 does not have enough memory space to house the received ROA, the installation process may be terminated in step 1207, and the processor may generate a no-sufficient-space message which may be presented to the robot user on the touch sensitive screen 107 via the display device 201. If, on the other hand, the autonomous robot 101 such as the robot computing device 103 is determined to have sufficient memory space, the installation process may proceed to step 1208. In step 1208, the processor may install the received ROA to the robot computing device memory. In step 1209, the processor may generate an installation completion message, which may be presented to the robot user on the touch sensitive screen 202 via the display device 201. Following the installation of the ROA on the autonomous robot, the processor may register of the installed ROA on the robot interface device, such that the installed ROA may be identified, located, and retrieved in the future via the robot interface device.

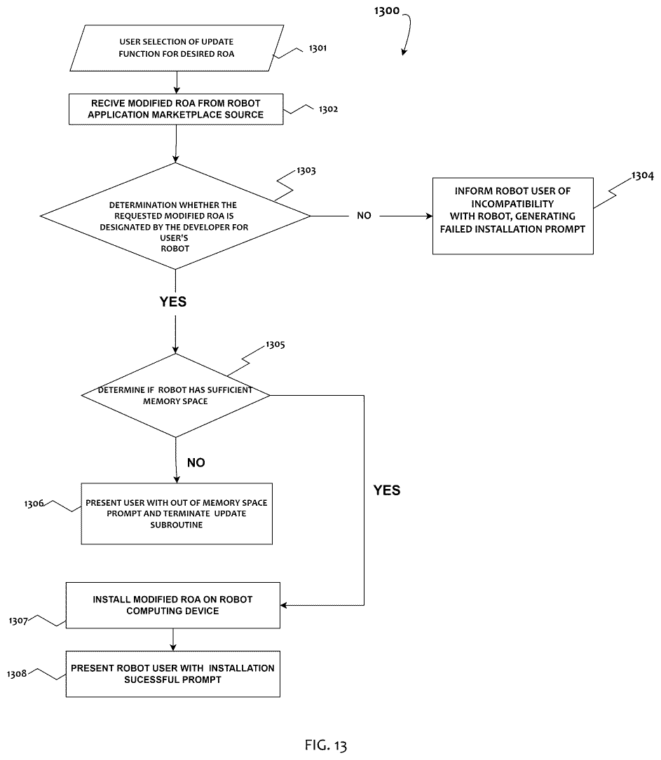

FIG. 13 shows the flowchart of an algorithm of an update subroutine 1300 according to an embodiment of the present invention. When executed by a processor, the update
subroutine 1300 may cause the processor to perform the following steps. In step 1301 the processor may receive an input from the robot user via the robot interface device 201 requesting an update 405 of a current ROA. In step 1302, the processor may receive a Robot oriented application from the robot application store remote server via a computer interactive network which may be accessed using the communication device of the autonomous robot. The ROA modification may in some embodiments be a data patch that can be used for updating or upgrading the currently installed ROA. In other embodiments, the ROA modification may be a later version of the currently installed ROA.

In step 1303 the processor may determine if the received modified ROA is designated for use on the relevant autonomous robot. The said determination may be based on one or more of the type, make, model and/or year of manufacture of the autonomous robot 101. If the processor determines the received modified ROA is not designated for use on autonomous robot 101 the update process may be terminated and the processor may, in step 1304, present an update failed report, which may be presented to the robot user on the touch sensitive screen 202 via the display device 201.

In another configuration, if the processor determines the modified ROA is designated for use on the autonomous robot, the update process may proceed to step 1305. In step 1305 the processor may determine if there is available memory space in the autonomous robot 101, such as the robot computing device 103 memory for storing the received modified ROA. In step 1306, If the robot computing device 103 does not have enough memory space to house the received ROA modification, the update process may be terminated, and the processor may generate a no-sufficient-space message which may be presented to the robot user on the touch sensitive screen 201 via the display device 202. On the other hand, if the robot computing device has sufficient memory space, the update process may proceed to step 1307. In step 1307, the processor may update the target ROA with the verified ROA modification. In step 1308, the processor may present the robot user with an update-successful prompt, which may be presented to the robot user on the touch sensitive screen 202 via the display device 201. The processor may, following the update of the ROA, re-register the updated ROA on the robot interface device, such that the updated ROA may be identified, located, and retrieved in the future via the robot interface device as shown in the example of FIG. 5.

FIG. 14 depicts a flowchart of an algorithm of an ROA Launch subroutine, according to an embodiment of the present invention. When executed by a processor, the launch subroutine 1400 may cause the processor to perform the following method steps. In step 1401 the processor may receive an input from the robot user via the robot interface device 102—which may be a display device presenting a Launch interactive option 406 as shown in FIG. 4—requesting the launch 406 of a ROA.

In step 1402, the processor may launch the selected ROA. The processor may load the selected ROA from the autonomous computing device memory to a processor of the autonomous robot such as the robot interface device processor and/or the robot computing device processor. The autonomous robot processor may execute the instruction codes of the selected ROA.

In embodiments, a robot user may override or terminate the operation of a launched ROA. The robot user may override the operation of an ROA by launching another application that interrupts the operation of the initially launched ROA, in which case the operation of the initially launched ROA may be suspended. The robot user may on the other hand outright terminate the operation of the ROA. The launch subroutine of the ROA may cause the autonomous robot processor(s) to constantly, periodically, or iteratively detect operator input during the execution of the launched ROA.

In step 1403, the processor may determine whether an override signal or a termination signal is detected. Generally, an override signal may be the launch of a different ROA by the robot user which interrupts or interferes with the operation of the initially launched ROA. The override signal may be received via input from the robot user via the robot interface device 102. A termination signal on the other hand is a robot user input of a terminate command requesting complete termination of the operation of a launched ROA. The termination signal may be received via input from the robot user via the robot interface device 102.

In step 1404 if an override signal is detected which may be a launch of another ROA by the robot user, the processor may determine whether the launched ROAs can operate conterminously.

In step 1405, If the processor determines the launched applications cannot operate conterminously the processor may stop processing the instructions of the initially launched ROA, suspending the operations of the initially launched ROA. The processor may end the suspension of the initially launched ROA and may continue processing the instructions of the suspended ROA if the operation of the ROA that generated the interrupt signal and subsequent suspension is terminated as seen in step 1406.

In step 1407 the processor may determine whether a command requesting a complete termination of the operation of a launched ROA has been detected. In step 1408 if the processor determines a Terminate signal has been detected the processor may stop processing the instructions of the ROA and end the operation of the terminated ROA.

The foregoing discussion has been presented for purposes of illustration and description. The foregoing is not intended to limit the disclosure to the form or forms disclosed herein. In the foregoing detailed description for example, various features of the disclosure are grouped together in one or more aspects, embodiments, and/or configurations for the purpose of streamlining the disclosure.

The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computer implemented method comprising;
Presenting to a robot user by one or more processors, via a robot's interface device, an applications store for robot-oriented applications, the store providing a plurality of applications available for installation on the robot. Wherein the application store makes the said presentation of the plurality of robot-oriented applications to the robot user based on an industry-use categorization;
Receiving from the robot user, a request to install at least one of the plurality of applications on a robot computing device;
Determining by one or more processor the compatibility of one or more selected robot-oriented applications with the robot on which the computing device is located and based on this determination, enabling, or disabling the install function of the application store; and
Installing, where the install function is enabled, by one or more processors, at least one of the selected one of the plurality of applications on the robot.

2. The method of claim 1, wherein the installation step includes the steps of;
Receiving the robot-oriented application from a server,
Checking if there is enough memory space on the robot computing device,
Storing the received robot oriented application on the robot computing device memory.

3. The Method of claim 1 wherein the said determination of compatibility is made based on one or more data received by the processor of the type, make, model and/or year of manufacture of the robot.

4. The method of claim 1 wherein the plurality of applications provided on the applications store comprise applications directed to one or more of the following; robot control applications, application associated with at least one robot task, function, and operation, application related to accessibility robot graphical user interfaces web browser applications, communications applications, entertainment applications, robot diagnostics applications, robot productivity applications, weather information application, emergency service application, robot manual related application, robot tracking application utility applications and other various forms of applications that may enhance the functionalities of autonomous robots.

5. A Tangible, Non-transient Computer Readable Medium having recorded thereon instructions, that when executed perform operations comprising;
Presenting to a Robot User by one or more processors on a robot's interface device, an application store for robot-oriented applications, the application store providing a plurality of applications available for installation on the robot's computing device. Wherein the application store makes the said presentation of the plurality of robot-oriented applications to the robot user based on an industry-use categorization;
Receiving from the robot user, a request to install at least one of the plurality of applications on a robot computing device;
Determining by one or more processors, the compatibility of the selected application with the robot on which the computing device is located and based on this determination, enabling, or disabling the install function of the application store; and
Installing, where the install function is enabled, by one or more processors, at least one of the selected one of the plurality of applications on the robot computing device;

6. The computer readable medium of claim 5, wherein the installation step includes the steps of;
receiving the robot-oriented application from a server,
checking if there is enough memory space on the robot computing device,
storing the received robot oriented application on the robot computing device memory.

7. The computer readable medium of claim 5, wherein the said determination of compatibility is made based on one or more data received by the processor of the type, make, model and/or year of manufacture of the robot.

8. The computer readable medium of claim 5, wherein the plurality of applications comprise applications directed to one or more or the following; robot control applications, application associated with at least one robot task, function, and operation, application related to accessibility robot graphical user interfaces web browser applications, communications applications, entertainment applications, robot diagnostics applications, robot productivity applications, weather information application, emergency service application, robot manual related application, robot tracking application utility applications and other various forms of applications that may enhance the functionalities of autonomous robots.

9. A Device, comprising one or more processors operable to:
Present to a Robot User an application store for robot-oriented applications, the application store providing a plurality of applications available for installation on the robot's computing device. Wherein the application store makes the said presentation of the plurality of robot-oriented applications to the robot user based on an industry-use categorization;
Receive from the robot user, a request to install at least one of the plurality of applications on a robot computing device;
Determine the compatibility of the selected application with the robot on which the computing device is located and based on this determination, enabling, or disabling the install function of the application store; and
Install, where the install function is enabled, by one or more robot processors, at least one of the selected plurality of applications on the robot computing device;

10. The device of claim 9, wherein the processor is further operable to determine the compatibility of the selected robot oriented application based on one or more data received by the processor of the type, make, model and/or year of manufacture of the robot.

11. The device of claim 9 wherein the said installation comprises of,
receiving the robot-oriented application from a server,
checking if there is enough memory space on the robot computing device,
storing the received robot-oriented application on the robot computing device memory.

12. The device of claim 9, wherein the plurality of applications comprise applications directed to one or more or the following; robot control applications, application associated with at least one robot task, function, and operation, application related to accessibility robot graphical user interfaces web browser applications, communications applications, entertainment applications, robot diagnostics applications, robot productivity applications, weather information application, emergency service application, robot manual related application, robot tracking application utility applications and other various forms of applications that may enhance the functionalities of autonomous robots.
